(19) United States
(12) Patent Application Publication
(10) Pub. No.: US 2026/0366901 A1
(43) Pub. Date: Nov. 19, 2026

(54) Apparatus and Method for Capacitive Fill-Level Measurements

(71) Applicant: Siemens Aktiengesellschaft, Muenchen (DE)

(72) Inventor: Stefan KLEHR, Rheinzabern (DE)

(21) Appl. No.: 19/141,141

(22) PCT Filed: Nov. 28, 2023
(86) PCT No.: PCT/EP2023/083408

§ 371 Date: Jun. 19, 2025

(30) Foreign Application Priority Data
Dec. 22, 2022 (DE) 102022004866.3

(51) Int. Cl. G01F 23/263

(52) U.S. Cl. CPC G01F 23/265; G01F 23/266; G01F 23/268

(57) ABSTRACT

An apparatus for capacitive fill-level measurement on an outer wall of a fluid container filled with at least one first fluid includes at least a first capacitor and a second capacitor, which are arranged parallel to one another along a longitudinal direction of the capacitors and which can be mounted on the outer wall of the fluid container, a sensing device that applies a voltage to the capacitors, with temporal staggering, and senses an electric charge of each of the capacitors to metrologically determine a capacitance of each of the capacitors, wherein the sensing device also compares the metrologically sensed capacitances of the capacitors with one another and determines a fill level of the fluid container based on this comparison, taking into account a positioning specification with respect to the fluid container.

### CROSS-REFERENCE TO RELATED APPLICATIONS

This is a U.S. national stage of application No. PCT/EP 2023/083408 filed 28 Nov. 2023. Priority is claimed on German Application No. 10 2022 004 866.3 filed 22 Dec. 2022, the content of which is incorporated herein by reference in its entirety.

### BACKGROUND OF THE INVENTION

### 1. Field of the Invention

The invention relates to an apparatus for capacitive fill-level measurement on an outer wall of a fluid container filled with at least one first fluid, further relates to a system with the apparatus and the fluid container and additionally relates to a method for capacitive measurement of a fill level of the fluid container filled with at least one first fluid.

### 2. Description of the Related Art

In the chemical industry, glass or plastics containers are often used for storage or for chemical reactions. In order to sense the fill level in the containers, a simple printed numerical scale on the container wall for manual read-off (in the manner of a measuring beaker) is often sufficient. Often, the instrumentation of measuring equipment for sensing the fill level is dispensed with for a variety of reasons, such as cost or for avoiding contact with media.

Furthermore, there are often different liquids in a container, so that a boundary layer forms (e. g., water and oil). In order to sense the fill levels of both fluids such that they can be differentiated from one another, and/or separately, a simple non-media contacting instrumentation is not possible.

Many containers are not stationary and therefore a permanently wired measuring installation for sensing the fill level is not desirable. A battery-powered and wireless solution would be advantageous.

WO 2023/036423 A1 discloses a capacitive reading apparatus for a pointer instrument.

### SUMMARY OF THE INVENTION

It is an object of the invention to provide an apparatus and an associated method for capacitive measurement of a fill level that can be undertaken with little effort and minimally invasively.

This and other objects and advantages are achieved in accordance with the invention by an apparatus for capacitive fill level measurement on an outer wall of a fluid container filled with at least one first fluid, a system, and by a method for capacitive measurement of a fill level of a fluid container filled with a first fluid.

An apparatus in accordance with the invention for capacitive fill-level measurement on an outer wall of a fluid container filled with at least one first fluid comprises at least a first capacitor and a second capacitor that are arranged parallel to one another along a longitudinal direction of the capacitors and that can be mounted on the outer wall of the fluid container, and a sensing device that is configured to apply an electric voltage to the capacitors, preferably with temporal staggering, and that is configured to sense an electric charge on each of the capacitors in order to determine metrologically a capacitance of each of the capacitors, where the sensing device is further configured to compare the metrologically sensed capacitances of the capacitors with one another and, based on this comparison, taking account of a positioning specification with respect to the fluid container, to determine a fill level of the fluid container.

The apparatus in accordance with the invention can be easily mounted on the outer wall of a fluid container. The capacitors are arranged along a longitudinal direction parallel to one another. In other words, the capacitors are arranged offset parallel to one another.

The sensing device of the apparatus in accordance with the invention is configured to apply an electric voltage, preferably with temporal staggering, to the capacitors. Dependent upon a permittivity of a fluid situated in the fluid container, a particular electric charge forms in the respective capacitor. This charge is measured by the sensing device. From the measured charge and the applied voltage, the sensing device determines a capacitance of the respective capacitor. The application of the electric voltage can simultaneously occur to a plurality, or all, of the capacitors. However, they can also have the electric voltage applied to them with temporal staggering and/or sequentially to prevent or at least reduce mutually parasitic influences on the later sensed capacitances.

The sensing device is further configured to compare the sensed capacitances of the two capacitors. If the sensing device establishes that both the capacitors have a capacitance that is to be expected for the medium air, then it is to be assumed that the fill level in the fluid container is very low and does not reach as far as the first capacitor. If, however, the capacitance of both capacitors is significantly greater, then it should be assumed that the fill level in the fluid container is high and reaches above both the capacitors. If the capacitances of both the capacitors differ from one another in the context of the measuring accuracy, then it should be assumed that the fill level in the fluid container reaches as far as the height of the first capacitor.

In order that an absolute fill level can be given with the apparatus in accordance with the invention, a positioning specification must be provided to the sensing device. This defines the height at which the apparatus is mounted on the fluid container. It thus represents an “offset” which, in the simplest case, is zero. The sensing device recognizes the spacing of the capacitors from one another. Together with the positioning specification, from this it can calculate exactly what fill level the fluid container has.

The sensing device can be situated in direct spatial proximity to the capacitors and arranged, in particular, within a shared housing. However, at least the part of the sensing device that compares the capacitances and determines the fill level can also be formed remote from the capacitors, for example, in a cloud-based computer environment.

The apparatus in accordance with the invention has the advantages that no movable mechanical parts are needed for the measurement of the fill level. In addition, readily available standard components can be exclusively used. Furthermore, the apparatus does not engage in the fluid container, which would be problematic, in particular, for chemically reactive fluids. The measurement of the fill level is also not restricted to a single fluid in the fluid container. Rather, with N capacitors, up to N different fluids can be detected.

It is evident that the invention is not restricted to only two capacitors. Rather, the apparatus can have a larger number of three or more capacitors. The following principle applies: the larger the number of capacitors, the higher is the spatial resolution. With a larger number of capacitors, the fill level can therefore be given more exactly.

Preferably, the apparatus has a screen for electromagnetic screening of the capacitors, in particular, from one another. The apparatus in accordance with the invention is configured to sense capacitance changes arising due to the different permittivities of different fluids within the fluid container. For this purpose, it is suitable if the capacitors are screened against undesirable electromagnetic influences via a suitable screen. In particular, the capacitors can be electromagnetically screened from one another to prevent or at least minimize falsification of the measurement results.

The sensing device can be a capacitance-to-digital converter, which preferably has a measurement resolution of at least 24 bits.

In addition, the sensing device can comprise a multiplexer that has at least two voltage outputs, each of which is conductively connected to a capacitor (more exactly: each of the voltage outputs is connected to an electrode of a capacitor). In the case of three or more capacitors, the multiplexer can have correspondingly more voltage outputs.

Preferably, the electrical potential of a voltage output of the multiplexer to which no electric voltage is applied corresponds to the electric potential of the screen. In this way, the capacitor and/or the capacitors that are currently not supplied with a voltage function as additional screening for the capacitor that is supplied with a voltage and is currently being used for the sensing of the capacitance.

A printed circuit board (PCB) can serve as the carrier element for the electrodes/capacitors. Alternatively, the carrier element could be a printed flexible film such as a polyimide or a PU film.

In the context of a preferred embodiment of the invention, the apparatus comprises at least a first, a second and a third capacitor that are arranged parallel to one another along a longitudinal direction of the capacitors. Therein, the second capacitor is arranged in the longitudinal direction between the first and the third capacitor. Therein, a voltage output of the multiplexer is conductively connected to the first and the third capacitor, whereas another voltage output of the multiplexer is conductively electrically connected to the second capacitor. The underlying concept consists therein that the voltage outputs of a multiplexer can be connected to a plurality of capacitors. In this way, a higher resolution for the fill level can be achieved without a multiplexer with this many voltage outputs being needed.

The objects and advantages are also achieved in accordance with the invention by a system that comprises a fluid container filled with one or more fluids and an apparatus configured in accordance with the disclosed embodiments. The apparatus is therein mounted on the outer wall of the fluid container, where the longitudinal direction of the capacitors of the apparatus is oriented in the direction of the fill level of the fluid container that is to be measured. In other words, the apparatus is oriented in the vertical direction on the fluid container and is fastened there an a suitable way (gluing, clamping, etc.).

The objects and advantages are also achieved in accordance with the invention by a detection system that comprises a large number of apparatuses as described above that are connected to one or more higher-level evaluating units, where the apparatuses are preferably arranged in a pipeline. The outer wall of the fluid container is therein preferably made from plastics or glass.

The objects and advantages are additionally achieved in accordance with the invention by a method for capacitive measurement of a fill level of a fluid container filled with at least a first fluid, comprising:
a) mounting an apparatus on an outer wall of the fluid container, where the apparatus has at least a first capacitor and a second capacitor that are arranged parallel to one another along a longitudinal direction of the capacitors, and a sensing device,
b) applying, by the sensing unit, an electric voltage, preferably with temporal staggering, to the capacitors,
c) sensing, by the sensing unit, an electric charge on each of the capacitors resulting from the application of the electric voltage,
d) determining metrologically, by the sensing unit, the capacitance of each of the capacitors based on the applied electric voltage and the sensed electric charge, and e) comparing the metrologically sensed capacitances of the capacitors in order therefrom to determine the fill level of the fluid container.

The sensing device can therein be a capacitance-to-digital converter, which preferably has a measurement resolution of at least 24 bits and that senses the electric charge on each of the capacitors resulting from the application of the electric voltage and metrologically determines the capacitance of each of the capacitors.

In addition, the sensing device can comprise a multiplexer that has at least two voltage outputs, each of which is conductively connected to a capacitor and via which the electric voltage is applied to each of the capacitors.

Preferably, the apparatus comprises at least a first, a second and a third capacitor, which are arranged parallel to one another along the longitudinal direction of the capacitors, where the second capacitor is arranged in the longitudinal direction between the first and the third capacitor, where a first voltage output of the multiplexer is conductively connected to the first and the third capacitor, where a second voltage output of the multiplexer is electrically conductively connected to the second capacitor, where an electric voltage is applied to the first and the third capacitor via the first voltage output of the multiplexer, and where an electric voltage is applied to the second capacitor via the second voltage output of the multiplexer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will now be described more clearly and explicitly with the following description of the exemplary embodiments, which are described in greater detail by reference to the drawings, in which:

FIG. 1 shows a schematic illustration of a system with an apparatus and a fluid container in accordance with the invention;

FIG. 2 shows an illustration of the principle for the measurement of a capacitance via an apparatus in accordance with the invention;

FIG. 3 shows a circuit diagram of a portion of an apparatus in accordance with the invention;

FIG. 4 shows a perspective view of an embodiment of an apparatus in accordance with the invention;

FIG. 5 shows a side view of an apparatus in accordance with the invention;

FIG. 6 shows a perspective view of an embodiment of an apparatus in accordance with the invention;

FIG. 7 shows an aspect of a method in accordance with the invention;

FIG. 8 shows a circuit diagram of a portion of a further apparatus in accordance with the invention;

FIG. 9 shows an aspect of an apparatus in accordance with the invention;

FIG, 10 shows a side view of an apparatus in accordance with the invention;

FIG. 11 shows a schematic illustration of a measurement performed via the apparatus in accordance with the invention; and

FIG. 12 is a flowchart of the method in accordance with the invention.

### DETAILED DESCRIPTION OF THE EXEMPLARY EMBODIMENTS

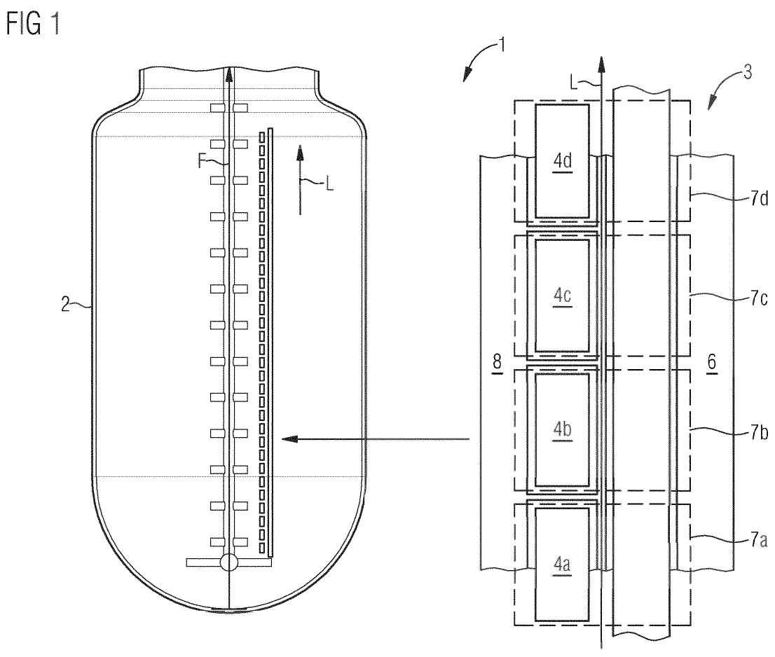

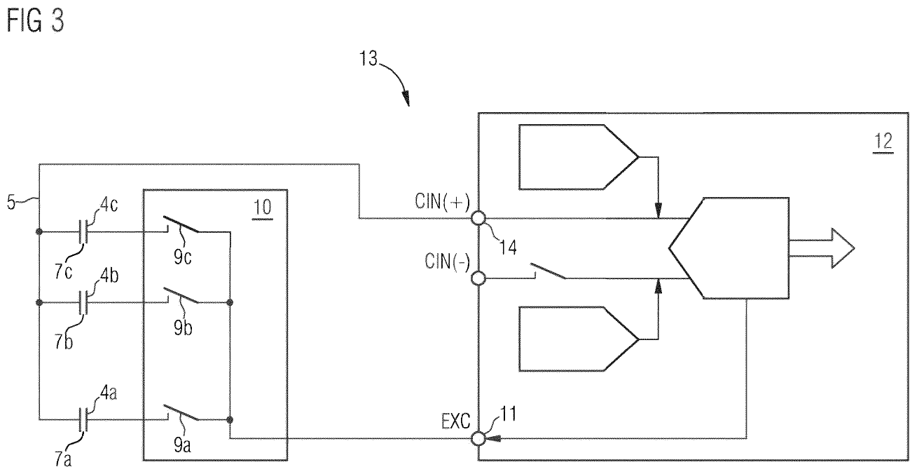

FIG. 1 shows the side view of a system 1 in accordance with the invention. The system 1 comprises a fluid container 2, an apparatus 3 and a sensing device 13 (see FIG. 3). In the present case, the fluid container 2 is made of glass and can be filled with a fluid, such as water or oil. A fill level F of the fluid container is measured in FIG. 1 upwardly in a vertical direction from the lower edge (bottom) of the fluid container 2.

Only a portion of the apparatus 3 is shown in FIG. 1. This portion comprises four supply electrodes 4a, 4b, 4c, 4d, a sensor electrode 5 and an electromagnetic screen 6 arranged to the right of the sensor electrode 5 in FIG. 1, as well as a further screen 8 arranged to the left of the supply electrodes 4a, 4b, 4c, 4d. The screens 6, 8 can be produced, for example, from aluminum and can have the same electric potential.

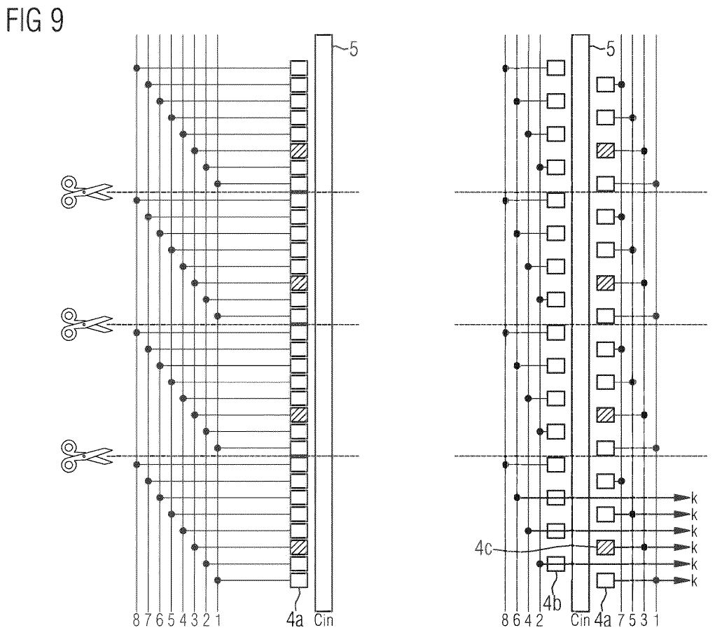

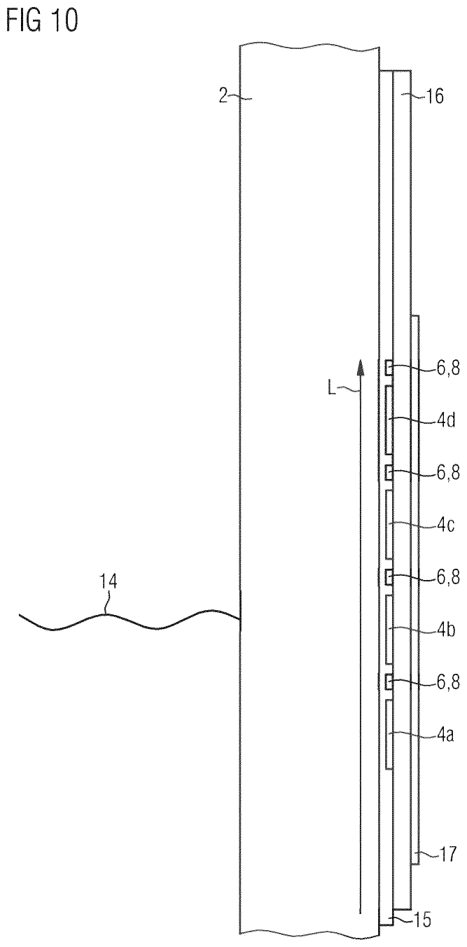

The supply electrodes 4a, 4b, 4c, 4d, together with the sensor electrode 5, form four capacitors 7a, 7b, 7c, 7d that are indicated with dashed outlines in FIG. 1. The electrodes 4a, 4b, 4c, 4d, 5 are arranged along a longitudinal axis L, for example, on a flexible printed film or a circuit board which, for reasons of clarity, are not shown in FIG. 1 (see FIG. 9). The portion of the apparatus 3 represented in FIG. 1 is mounted in a suitable way (adhesive, clamps, etc.) on an outer wall of the fluid container 2 (i.e., outside the fluid container 2). Therein, the portion of the apparatus 3 is arranged such that the longitudinal axis L of the supply electrodes 4a, 4b, 4c, 4d and/or the sensor electrode 5 matches a direction of the fill level F.

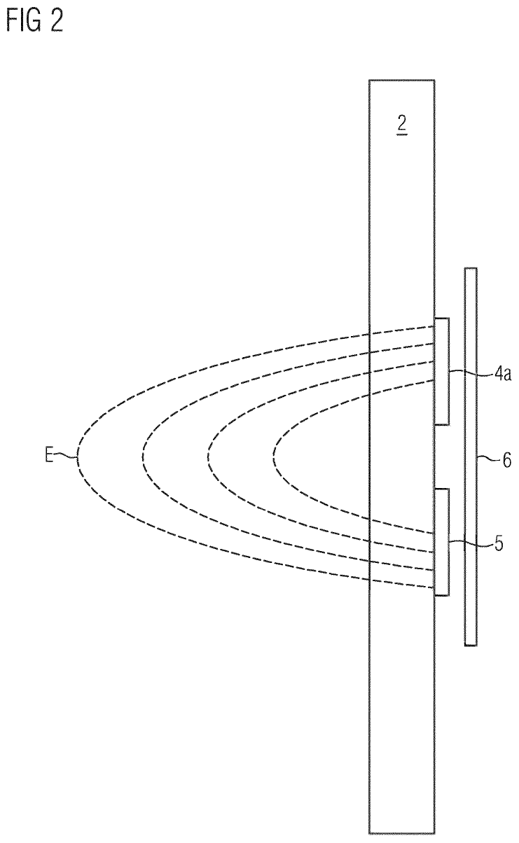

An electric voltage is applied to the supply electrodes 4a, 4b, 4c, 4d with temporal staggering, for which the sensing device 13 of the apparatus 3 as shown in FIG. 3 is responsible. FIG. 2 shows, by way of example, for a capacitor 7a of the four capacitors 7a, 7b, 7c, 7d from FIG. 1 in a sectional image, which is formed from a supply electrode 4a and the sensor electrode 5, the electric field E resulting from the application of the electric voltage. A portion of this electric field E extends through the fluid container wall 2 (sectional image) and is influenced by a permittivity of the fluid situated in the fluid container 2.

The electric voltage is provided by the sensing device 13 of the apparatus 3 illustrated in FIG. 3. FIG. 3 shows an electrical circuit plan of the sensing device 13 of the apparatus 3. Shown on the left side are three of the capacitors 7a, 7b, 7c. The supply electrodes 4a, 4b, 4c of the capacitors 7a, 7b, 7c are each connected to a voltage output 9a, 9b, 9c of a multiplexer 10. The multiplexer 10 is configured to apply an electric voltage with temporal staggering to the voltage outputs 9a, 9b, 9c. It receives this electric voltage from a voltage output 11 (“EXC”) of a capacitance-to-digital converter 12 of the sensing device 13. The capacitance-to-digital converter 12 can be, for example, an AD7745 from the firm Analog Devices. It can sense a capacitance range from 0 to 8 pF with a resolution of 24 bit. Therein, the capacitance is sensed via an input 14 (“CIN (+) ”) that is connected to the sensor electrode 5. The internal structure of the capacitance-to-digital converter 12 is not the subject matter of this invention and will therefore not be described in greater detail here.

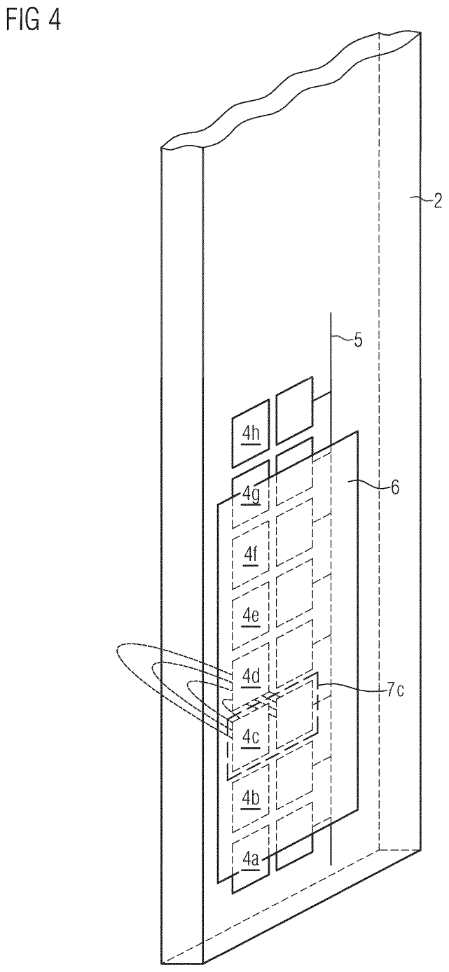

As the multiplexer 10, for example, the 3-to-8 line decoder 74xx238 from the firm Texas Instruments can be used. The multiplexer 10 places the voltage outputs 9a, 9b, 9c that have no voltage applied to them, at the same electric potential that the screen 6 also has. In this way, all the supply electrodes 4a, 4b, 4c, 4d that have no voltage applied to them serve as screening for the supply electrodes 4a, 4b, 4c, 4d to which a voltage is applied. In this regard, reference is also made to FIG. 4, which has eight supply electrodes 4a, 4b, 4c, 4d, 4e, 4f, 4g, 4h, a sensor electrode 5 and a screen 6, and is mounted on the fluid container 2. In FIG. 4, a voltage is applied to only one of the supply electrodes 4c. Exclusively the capacitor 7c formed by this supply electrode 4c and the sensor electrode 5 serves at the time point shown in FIG. 4 for capacitance measurement.

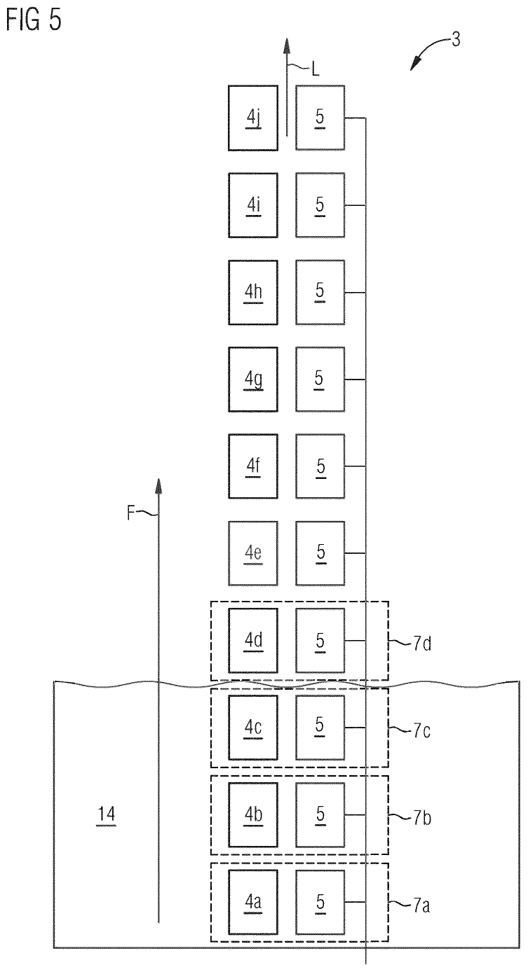

FIG. 5 illustrates how the capacitance values sensed by the sensing device 13 can be associated with the fill level F in the fluid container 2. The sensing device 13 applies an electric voltage to the first three capacitors 7a, 7b, 7c sequentially (from bottom to top) and senses the capacitance of each capacitor 7a, 7b, 7c. This is essentially influenced by a permittivity of a fluid 14 situated in the fluid container 2. On the transition to the fourth capacitor 7d, there is no more fluid 14 in the fluid container 2, which influences the electric field generated by the capacitor 7d and ultimately the capacitance that is sensed. By way of a comparison of the capacitance measured on the fourth capacitor 7d with the capacitance measured on the third capacitor 7c, a fill level F in the fluid container 2 can be deduced. The spacing of the capacitors 7a, 7b, 7c, 7d from one another therein determines the resolution with which the fill level can be determined.

Each supply electrode 4a, 4b, 4c, 4d, 4e, 4f, 4g, 4h, 4i, 4j must therein be connected to a voltage output 9a, 9b, 9c of the multiplexer 10. The quantity of electrode numbers can also be equal to the quantity of electrodes that can be switched for measuring. In the case of an 8-to-1 multiplexer 10, of eight supply electrodes 4a, 4b, 4c, 4d, 4e, 4f, 4g, 4h, respectively one can be activated for measuring. If these eight electrodes are simply placed parallel to one another, the fill level can be determined only within the measuring section in which the eight electrodes are arranged.

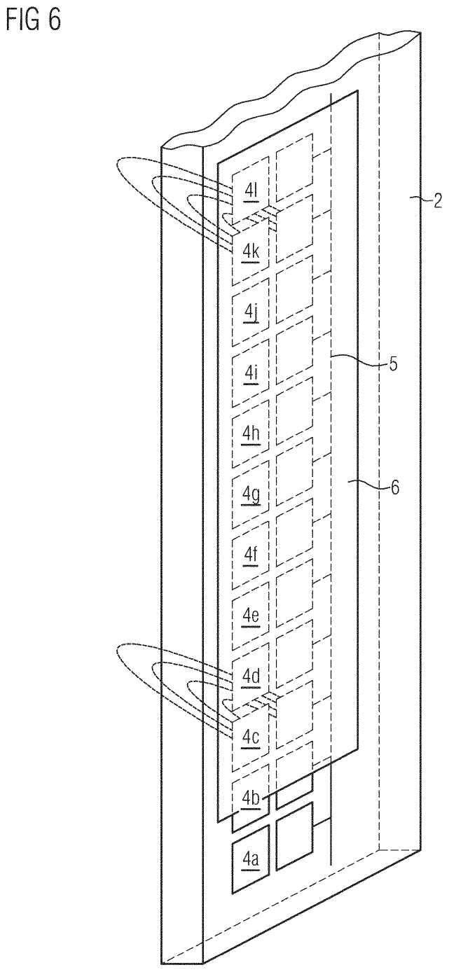

If it is now desired to sense the fill level of the entire container with a resolution of, for example, 1% of the measurement range, then in accordance with the above scheme, 100 supply electrodes would have to be arranged in a linear manner. Thus a 100-to-1 multiplexer 10 would be needed, which would be complex from the standpoint of the circuitry. A solution for this is provided by the embodiment shown in FIG. 6. Each voltage output 9a, 9b, 9c of the multiplexer 10 is connected to two or more supply electrodes 4a, 4b, 4c, 4d, 4e, 4f, 4g, 4h, 4i, 4j, 4k, 4l. In the case of multiple use, the capacitance measurement range of the sensing unit 13 is dimensioned such that the signal output only reaches 100% when the fluid has reached all the supply electrodes 4a, 4b, 4c, 4d, 4e, 4f, 4g, 4h, 4i, 4j, 4k, 4l associated with a respective voltage output 9a, 9b, 9c and 50% when it has reached half of the associated supply electrodes 4a, 4b, 4c, 4d, 4e, 4f, 4g, 4h, 4i, 4j, 4k, 4l.

In this way, with relatively few voltage outputs from the multiplexer 10, a large number of supply electrodes 4a, 4b, 4c, 4d, 4e, 4f, 4g, 4h, 4i, 4j, 4k, 4l can be placed and thereby a high spatial resolution can be achieved.

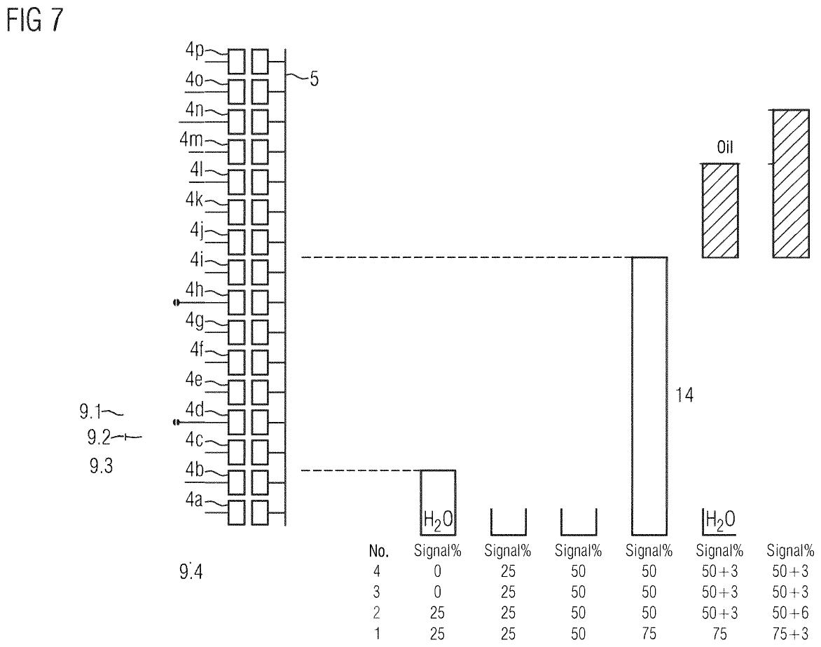

FIG. 7 shows a further explanatory example. Herein, the apparatus 3 has 16 supply electrodes 4a, 4b, 4c, 4d, 4e, 4f, 4g, 4h, 4i, 4j, 4k, 4l, 4m, 4n, 4o, 4p and one sensor electrode 5. Herein, the multiplexer 10 has four voltage outputs 9.1, 9.2, 9.3, 9.4 (similar to the voltage outputs 9a, 9b, 9c in the previous figures) that are each connected to four of the supply electrodes 4a, 4b, 4c, 4d, 4e, 4f, 4g, 4h, 4i, 4j, 4k, 4l, 4m, 4n, 4o, 4p. Therein, for example, the first voltage output 9.1 is connected to the first supply electrode 4a, the fifth supply electrode 4e, the ninth supply electrode 4i and the thirteenth supply electrode 4m. The spacing between the supply electrodes 4a, 4e, 4i, 4m connected to the voltage output is therefore four supply electrodes in each case. This applies similarly for the other voltage outputs 9.2, 9.3, 9.4.

On the right side, different fill heights 14 of fluids (water and oil) are represented. In the tabular listing thereunder, the signal output level of the sensed capacitance, in each case, with respect to a voltage output 9.1, 9.2, 9.3, 9.4 is shown. For the first column, the fill level of the water reaches as far as the second supply electrode 4b and/or the second capacitor. The first supply electrode 4a is connected to the first voltage output 9.1, the second supply electrode 4b is connected to the second voltage output 9.2. The signal output level of the capacitance sensed in relation to the respective voltage output 9.1, 9.2 is 25%, because the fill level does not reach the other supply electrodes connected to the two voltage outputs 9.1, 9.2. For the second, third and fourth columns, signal output levels are formed similarly. For the fifth column, the water reaches as far as the ninth supply electrode 4i. This results in a signal output level of 50% for each of the capacitances in relation to the second, third and fourth voltage outputs 9.2, 9.3, 9.4 and 75% for the capacitance in relation to the first voltage output 9.1.

For the capacitances in relation to the second, third and fourth voltage outputs 9.2, 9.3, 9.4, a further 3% signal output is added on, because, in comparison with water, the oil causes only a slight capacitance increase. As a result, the sensing unit 13 can easily sense how high the fill level of the water and how high the fill level of the oil is, and for this purpose, needs only one multiplexer 10 with four voltage outputs.

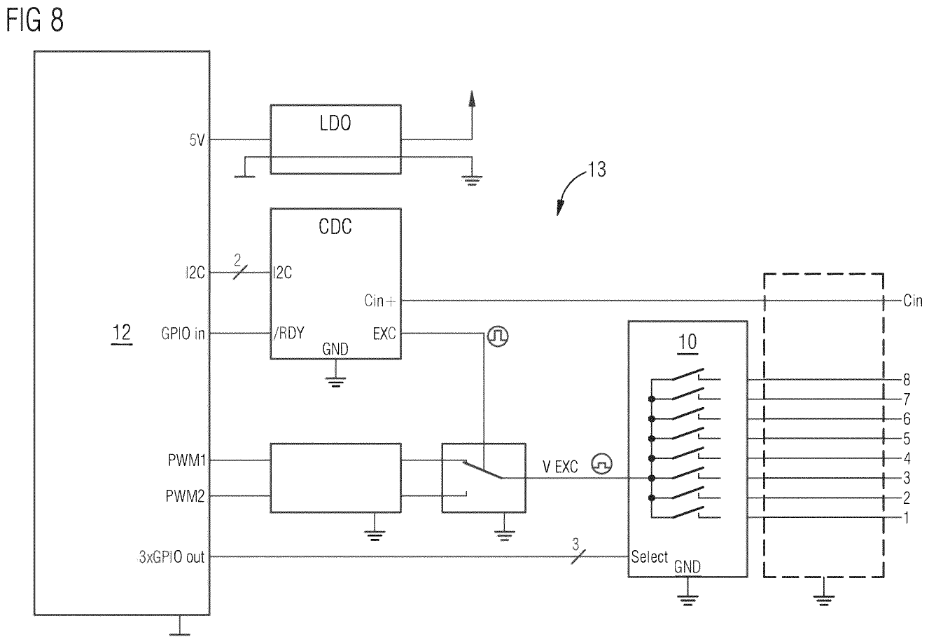

FIG. 8 shows a further embodiment of the sensing device 13 of the apparatus 3.

FIG. 9 shows further embodiments of the supply electrodes 4a, 4b, 4c with the sensor electrode 5. The circuit can be produced with greater length and then be brought, as desired, to the length suitable for the respective fluid container (for example, by cutting). On the right-hand side in FIG. 9 it is shown that the supply electrodes 4a, 4b, 4c do not have to be arranged directly parallel to one another, but can also be arranged in alternating manner about the sensor electrode 5.

What is important is only that their axes K are arranged substantially parallel to one another.

FIG. 10 shows a sectional image of the first part of an apparatus 3 in accordance with the invention. The supply electrodes 4a, 4b, 4c, 4d that are visible in FIG. 10 (and the sensor electrode 5 covered in FIG. 10 by the supply electrodes 4a, 4b, 4c, 4d) are fastened via an adhesive material 15 to the outer wall of the fluid container 2. It is also evident that parts of the screen 6, 8 are situated in the longitudinal direction L in order to screen the capacitors from one another. The electrodes 4a, 4b, 4c, 4d and the screens 6, 8 are mounted on a flexible film 16 and are made of copper or a conductive ink. The electrodes 4a, 4b, 4c, 4d, 5 have a thickness of 25 micrometers. Situated on this (in FIG. 10 beside it to the right) is a further screening layer 17. This can have a thickness of, for example, 35 micrometers.

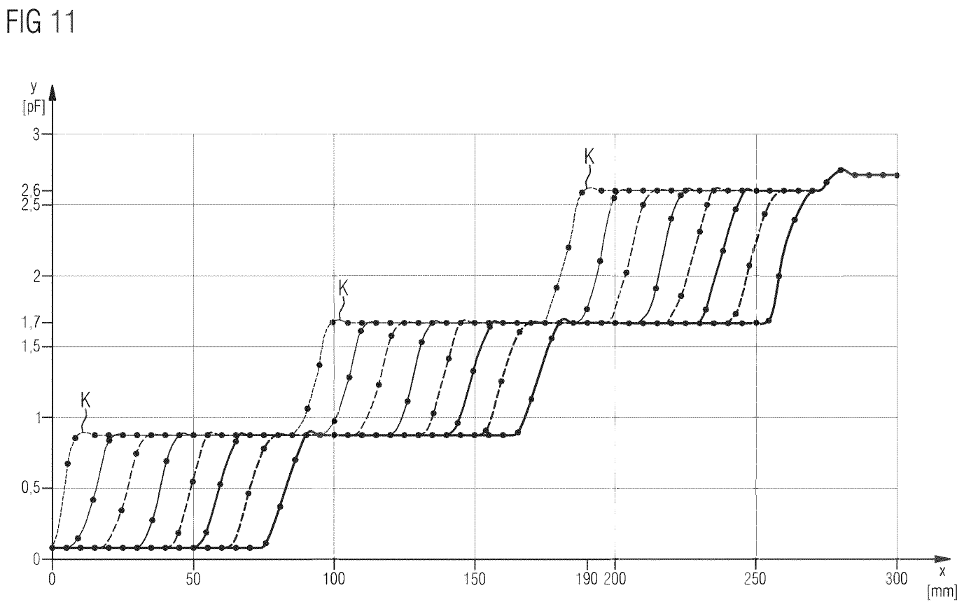

FIG. 11 shows the results of a measurement performed with 24 supply electrodes (3×8 with an 8-to-1 multiplexer). The electrodes are 20×10 mm in size and have a spacing from one another (in the direction of the longitudinal axis L) of 1 mm. The measurement range is 270 mm. The fill level in a fluid container was increased after each measurement in 5 mm steps. The capacitance changes in a stepped manner in 33% signal output steps (as a result of the 3 connected electrodes, i.e., 3 parallel-connected capacitors). The X-axis represents the fill level in the fluid container and the Y-axis the capacitance sensed for the eight supply electrodes (and/or the capacitors formed by them). Above a fill level of 100 mm, the channel associated with the first supply electrode (signified with K in FIG. 11) measures approximately 1.7 pF (66% capacitance signal output). Above 190 mm, the channel is at full output with 2.6 pF (100%).

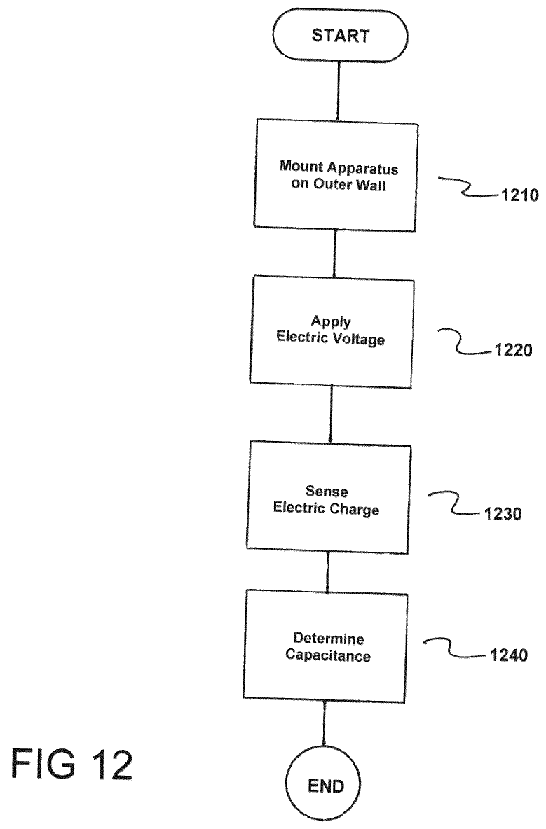

FIG. 12 is a flowchart of the method for capacitive measurement of a fill level F of a fluid container 2 filled with at least one first fluid.

The method comprises a) mounting an apparatus 3 on an outer wall of the fluid container 2, as indicated in step 1210. In accordance with the method, the apparatus 3 has at least a first capacitor 7a and a second capacitor 7b that are arranged parallel to one another along a longitudinal direction L of the capacitors 7a, 7b, and has a sensing device 13.

Next, b) an electric voltage is applied to the capacitors 7a, 7b with temporal staggering via the sensing device 13, as indicated in step 1220.

Next, c) an electric charge on each of the capacitors 7a, 7b resulting from applying the electric voltage is sensed via the sensing device 13, as indicated in step 1230.

Next, d) a capacitance of each of the capacitors 7a, 7b is determined metrologically via the sensing device 13 based on the applied electric voltage and the sensed electric charge, as indicated in step 1240.

Next, e) the metrologically sensed capacitances of the capacitors 7a, 7b are compared to determine the fill level of the fluid container 2, as indicated in step 1250.

Although the invention has been illustrated and described in detail by way of the preferred exemplary embodiment, the invention is not restricted by the examples disclosed and other variations can be derived therefrom by a person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-13. (canceled)

14. An apparatus for capacitive fill-level measurement on an outer wall of a fluid container filled with at least one first fluid, comprising:
at least a first capacitor and a second capacitor which are arranged parallel to one another along a longitudinal direction of the capacitors and which are mountable on the outer wall of the fluid container;
a sensing device which is configured to apply an electric voltage to the capacitors with temporal staggering, and to sense an electric charge on each of the capacitors to determine metrologically a capacitance of each of the capacitors;
wherein the sensing device is further configured to compare a metrologically sensed capacitances of the capacitors with one another and, based on said comparison, taking account of a positioning specification with respect to the fluid container, determine a fill level of the fluid container.

15. The apparatus as claimed in claim 14, further comprising:
a screen for electromagnetic screening of the capacitors from one another.

16. The apparatus as claimed in claim 14, wherein the sensing device comprises a capacitance-to-digital converter which has a measurement resolution of at least 24 bits.

17. The apparatus as claimed in claim 14, wherein the sensing device comprises a multiplexer which has at least two voltage outputs each of which is conductively connected to a respective capacitor.

18. The apparatus as claimed in claim 17, wherein the electric potential of a voltage output of the multiplexer to which no electric voltage is applied corresponds to an electric potential of a screen.

19. The apparatus as claimed in claim 14, wherein the first and second capacitors are arranged on a circuit board or a flexible film.

20. The apparatus as claimed in claim 17, further comprising:
at least the first, the second and a third capacitor, which are arranged parallel to one another along the longitudinal direction of the capacitors;
wherein the second capacitor is arranged in the longitudinal direction between the first capacitor and the third capacitor;
wherein a voltage output of the multiplexer is conductively connected to the first capacitor and the third capacitor; and
wherein another voltage output of the multiplexer is electrically conductively connected to the second capacitor.

21. A system comprising:
a fluid container filled with at least one fluid and the an apparatus as claimed in claim 14, the system being mounted on the outer wall of the fluid container;
wherein the longitudinal direction of the first and second capacitors of the apparatus is oriented in a direction of the fill level of the fluid container which is to be measured.

22. The system as claimed in claim 21, wherein the outer wall of the fluid container is made of plastics, ceramic or glass.

23. A method for capacitive measurement of a fill level of a fluid container filled with at least one first fluid, comprising:
a) mounting an apparatus on an outer wall of the fluid container, the apparatus having at least a first capacitor and a second capacitor which are arranged parallel to one another along a longitudinal direction of the capacitors, and having a sensing device,
b) applying, via the sensing device, an electric voltage with temporal staggering to the capacitors;
c) sensing, via the sensing device, an electric charge on each of the capacitors resulting from applying the electric voltage;
d) determining metrologically, via the sensing device, a capacitance of each of the capacitors based on the applied electric voltage and the sensed electric charge; and
e) comparing the metrologically sensed capacitances of the capacitors to determine the fill level of the fluid container.

24. The method as claimed in claim 23, wherein the sensing device comprises a capacitance-to-digital converter having a measurement resolution of at least 24 bits and which senses an electric charge on each of the capacitors resulting from the application of the electric voltage and metrologically determines the capacitance of each of the capacitors.

25. The method as claimed in claim 23, wherein the sensing device comprises a multiplexer which has at least two voltage outputs, each of which is conductively connected to a capacitor and via which the electric voltage is applied to each of the capacitors.

26. The method as claimed in claim 24, wherein the sensing device comprises a multiplexer which has at least two voltage outputs, each of which is conductively connected to a capacitor and via which the electric voltage is applied to each of the capacitors.

27. The method as claimed in claim 26, wherein the apparatus comprises at least a first, a second and a third capacitor, which are arranged parallel to one another along the longitudinal direction of the capacitors;
wherein the second capacitor is arranged in the longitudinal direction between the first capacitor and the third capacitor;
wherein a first voltage output of the multiplexer is conductively connected to the first capacitor and the third capacitor;
wherein a second voltage output of the multiplexer is electrically conductively connected to the second capacitor;
wherein an electric voltage is applied to the first capacitor and the third capacitor via the first voltage output of the multiplexer; and
wherein an electric voltage is applied to the second capacitor via the second voltage output of the multiplexer.
